(19) United States
(12) Patent Application Publication
(10) Pub. No.: US 2012/0192063 A1
(43) Pub. Date: Jul. 26, 2012

(54) ON-THE-FLY TRANSFORMATION OF GRAPHICAL REPRESENTATION OF CONTENT

(76) Inventors: Ziv KOREN, Ramat Hasharon (IL); Sharon Tal, Tzur Moshe (IL)

(21) Appl. No.: 13/113,224

(22) Filed: May 23, 2011

Related U.S. Application Data
(60) Provisional application No. 61/434,581, filed on Jan. 20, 2011.

(51) Int. Cl. G06F 17/00

(52) U.S. Cl. 715/252

(57) ABSTRACT

A method, system and computer program product for receiving a request to obtain a web page to be displayed within a display component having a predetermined width; obtaining the web page, the web page having a first display representation, the first display representation having a layout of graphical elements, the first display representation having a different width than the predetermined width; determining a proportion between the predetermined width and the different width; generating a transformed web page based on the proportion, the transformed web page having a second display representation, the second display representation having the predetermined width, the second display representation retaining the layout of elements, wherein sizes of elements of the layout are proportionally modified based on the proportion.

### CROSS-REFERENCE TO RELATED APPLICATION

This application claims the benefit of U.S. Provisional Application No. 61/434,581 filed Jan. 20, 2011, which is hereby incorporated by reference.

### TECHNICAL FIELD

The present disclosure relates to representation of graphical content in general, and to transformation of the graphical content to be displayed in a different manner, in particular.

### BACKGROUND

When preparing content to be displayed graphically, a designer may consider the manner in which the content is displayed to a user. For example, when designing a web page, a designer may start of by setting an optimal resolution to be used for displaying the web page (e.g., 800×600, 1024×768). The designer may then design the web page relying on the width of the screen.

In some cases, a content display apparatus, such as a computer having installed thereon a web browser, may display the content even when the optimal requirements are not met. If the width of the graphical representation of the content, also referred to as a width of the content, such as measured in pixels, is less than the width of the display, the content display apparatus may display content centered within the width available for display. Alternatively, if the width of the content is wider than that of the display, the content display apparatus may display portions of the content and optionally provide a scrollbar for the user to modify the portion being displayed. However, when the content display apparatus is displaying the content using non-optimal display, the user experience of viewing and/or interacting with the content may be negatively affected.

### SUMMARY

One exemplary embodiment of the disclosed subject matter is a computer-implemented method, the method performed by a computerized device, the method comprising: receiving a request to obtain a web page to be displayed within a display component having a predetermined width; obtaining the web page, the web page having a first display representation, the first display representation having a layout of graphical elements, the first display representation having a different width than the predetermined width; determining a proportion between the predetermined width and the different width; generating a transformed web page based on the proportion, the transformed web page having a second display representation, the second display representation having the predetermined width, the second display representation retaining the layout of elements, wherein sizes of elements of the layout are proportionally modified based on the proportion.

Another exemplary embodiment of the disclosed subject matter is a proxy server, the proxy having a processor and memory device, the proxy comprising: a request obtainer operable to obtain a request to retrieve a web page to be displayed within a display component having a predetermined width; a web page obtainer operable to obtain the web page from a web server, the web page having a first display representation, the first display representation having a layout of graphical elements, the first display representation having a width; a proportion determinator operative to determine a proportion between the predetermined width and the width; a web page transformer operative to generate a transformed web page based on the web page and the proportion, the transformed web page having a second display representation, the second display representation having the predetermined width, the second display representation retaining the layout of elements, whereby sizes of elements of the layout are proportionally modified based on the proportion.

Yet another exemplary embodiment of the disclosed subject matter is a computer program product, the product comprising: a non-transient computer readable medium; a first program instruction for receiving a request to obtain a web page to be displayed within a display component having a predetermined width; a second program instruction for obtaining the web page, the web page having a first display representation, the first display representation having a layout of graphical elements, the first display representation having a different width than the predetermined width; a third program instruction for determining a proportion between the predetermined width and the different width; a fourth program instruction for generating a transformed web page based on the proportion, the transformed web page having a second display representation, the second display representation having the predetermined width, the second display representation retaining the layout of elements, wherein sizes of elements of the layout are proportionally modified based on the proportion; and wherein the first, second, third, and fourth program instructions are stored on the non-transient computer readable medium.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a computerized environment in which the disclosed subject matter is used, in accordance with some exemplary embodiments of the subject matter;

FIGS. 2A and 2B showing an illustration of web pages, in accordance with some exemplary embodiments of the disclosed subject matter;

FIG. 3 shows a flowchart diagram of a method, in accordance with some exemplary embodiments of the disclosed subject matter;

FIG. 4 shows a block diagram of a proxy server, in accordance with some exemplary embodiments of the disclosed subject matter;

FIG. 5 shows a flowchart diagram of a method, in accordance with some exemplary embodiments of the disclosed subject matter;

FIG. 6 shows a flowchart diagram of a method of processing an image by a proxy parser, in accordance with some exemplary embodiments of the disclosed subject matter; and

FIG. 7 shows a flowchart diagram of a method of processing external objects by a proxy parser, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is to display a web page or similar graphical content having a pre-designed width in a component having a different width. For example, the component may be an inline frame (also referred to as iFrame) within another web page, so that the width available for the display is smaller. As another example, the component may be a web browser that is being displayed on a screen having a smaller resolution and therefore having different width available for display. It will be understood that generally width is measured in number of pixels and not actual size. Another technical problem is to design a web page and to include internally within the designed web page, in a component, such as an inline frame, another web page, even in case the width of the other web page is different than that of the component. Yet another technical problem is to maintain functionality of the web page, such as hyperlinks, Flash elements, JavaScript script or the like, and enable display of the linked web pages in the component. Yet another technical problem is to avoid having duplicate content issues with search engines as the modified web page is substantially the same as the original web page but may be considered different by the search engine. Search engines may determine that the owner of the web page utilizes unauthorized Search Engine Optimizations (SEO) techniques and remove the web page from the search engine or reduce its ranking. Yet another technical solution is to tunnel cookie directives in order to preserve saved information, so as to provide the client the same functional effect of the original website, including preserving of data, maintaining session objects or the like.

One technical solution is to utilize a proxy server configured to modify the size of the retrieved web page based on the proportions between the width of the web page and the width available for the display of the web page. Another technical solution is to dynamically transform the web page in response to a request to retrieve the web page. Yet another technical solution is to modify links in the web page to be directed to the proxy server, so as that when linked pages are retrieved, they are too, modified. Yet another technical solution is to compute the proportion between the widths and introduce/modify rendering directives by the determined proportion. Yet another technical solution is to preprocess the web page in the same manner that the requesting client would process the web page, thus reducing duplicate processing by the proxy and the client. The preprocessing may include removing irrelevant processing directives and performing relevant processing directive. In some exemplary embodiments, included files that are retrieved for the rendering of the web page may be retrieved by the proxy and inlined to the web page so as to reduce processing time at client side. Yet another technical solution is to introduce directives for search engines to avoid indexing the modified web page.

One technical effect of utilizing the disclosed subject matter is modifying the graphical representation of the web page in a dynamic manner. Thus, the retrieved web page is the latest version of the web page and not a cached version thereof. Another technical effect is to reduce added overhead processing time. It will be noted that in lieu of rendering the web page once, the web page may be rendered twice—once by the proxy, which processes it, and once by the client which renders the processed web page. Therefore, added processing time may hinder user's experience from the web page. The disclosed subject matter has the effect of reducing the added processing time. Yet another technical effect is to maintain the original layout of the web page in the modified version thereof. Yet another technical effect is to enable a web page designer to include in a third-party web page without having to modify the third-party web page, and using standard Hyper Text Markup Language (HTML) directives. Yet another technical effect is to avoid having an added scrollbar in the designed web page to display a web page within a component, such as an iFrame.

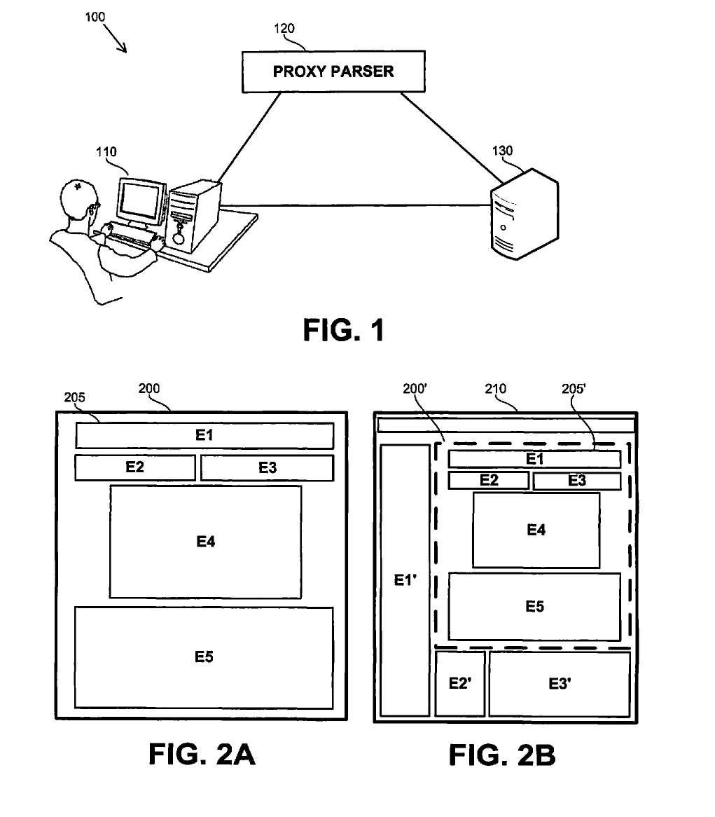

Referring now to FIG. 1 showing a computerized environment 100. The computerized environment 100 comprises a user using a computer 110, such as a Personal Computer (PC), a mobile device, a laptop computer, an embedded device or the like. The computer 110, also referred to as a client, may comprise an Internet Browser or a similar component or tool capable of displaying web pages, or otherwise be capable of providing this functionality. Instead of obtaining the web page from a server 130, such as a web server, the client 110 may obtain the web page using a proxy server 120. In some exemplary embodiments, a web page obtained from the Internet or other computer network may refer the client 110 to obtain the web page using the proxy server 120, such as for example using an inline frame directive, such as iFrame directive in HTML.

Referring now to FIGS. 2A and 2B showing an illustration of web pages, in accordance with some exemplary embodiments of the disclosed subject matter.

In FIG. 2A an illustration of a display is shown. The display shows page 200 as is designed to be displayed by the designer, developer or the like. The page 200 comprises a plurality of elements, such as images, text sections, Flash elements, or other objects. For example, element E1 205 may be an image, a text frame, a Flash object, a section of an HTML document (e.g., div tag), a banner, or the like. The page 200 has a predetermined layout of the elements.

In FIG. 2B a second page 210 comprises the page 200′ in an inline frame. The page 210 comprises elements such as the frame, E1′, E2′, E3′. In accordance with the disclosed subject matter, the frame may be an inline frame which directs a web browser displaying the second page 210 to fetch the page 200 from a proxy server 120 so as that the page 200 is dynamically processed and transformed to the processed version 200′. The processed version 200′ has the same layout as the page 200. The processed version 200′ is of smaller width than the page 200 and is reduced in accordance with a computed proportion between original width of the page 200 and width of the inline frame. For example, element E1 205′ is a smaller version of the element E1 205. The reduction in size is in the aforementioned computed proportion.

In some exemplary embodiments, the inline frame may or may not have a displayable border, a spacing from other elements or the like. In some exemplary embodiments, the processed version 200′ is reduced to the width of the inline frame so as to avoid requiring the browser to display a horizontal scrollbar.

In some exemplary embodiments, the processed page 200′ is modified so as that predetermined functionalities that require further fetching of additional objects are fetched via the proxy server 120 as well. For example, the additional functionalities may be hyperlinks, external objects such as a CSS, a Flash object, a JavaScript object, an image, or the like.

In some exemplary embodiments, the disclosed subject matter may be applied in a social network website, such as Facebook®, in a web portal or other sites in which user-content may be added. In such sites, the user may add a link to an external web page to be displayed within the site. For example, FIG. 2B may be the social network website and the processed page 200′ may be an external web page, such as a homepage, displayed within an iFrame in the website. In some exemplary embodiments, a company may publish its website using the social network website, thereby without requiring added effort, its website is displayed and may be shared by users of the social network. In some exemplary embodiments, such as in Facebook®, a user may open a designated page and configure the page to display a target web page. The page is displayed within Facebook®, enabling users to use menus and functionalities of Facebook®, and therefore leaving a reduced portion of the browser to display the target web page.

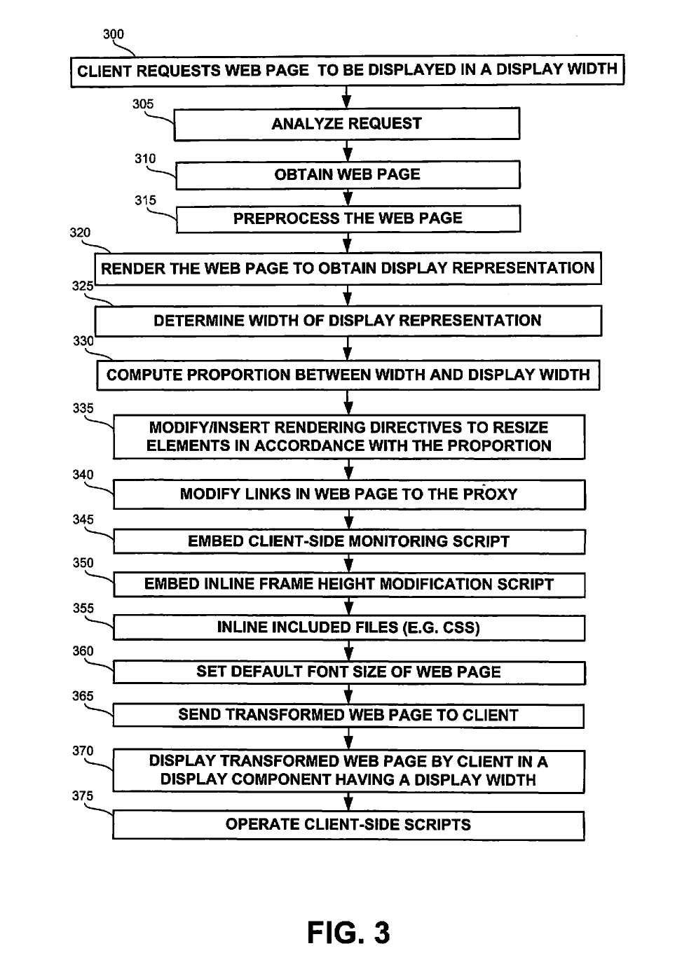

FIG. 3 shows a flowchart diagram of a method, in accordance with some exemplary embodiments of the disclosed subject matter.

In step 300, a client, such as 110 of FIG. 1, may request a web page to be displayed. The request may indicate available width to be used for displaying the page. The request may be a given in a predetermined protocol, such as a HyperText Transfer Protocol (HTTP), HTTP Secure (HTTPS) or the like. The request may comprise a URL of the web page, which directs to a domain and a path within the domain. The request may provide additional parameters to be provided to the server 130 in retrieving the web page, such as POST parameters, GET parameters, or the like. The request may be obtained by the proxy server 120.

In step 305, the request may be analyzed. The request may be analyzed to determine the display width. The request may be analyzed to determine the domain of the web page. Additional analysis may be performed in accordance with the disclosed subject matter. In some exemplary embodiments, the web page may be checked against a black-list. For example, the domain may be validated against a domain black-list in order to prevent loading content from blocked domains.

In step 310, the web page may be obtained from the server 130. The web page may be to obtained by initiating a request to the server 130 to retrieve the web page. The request may be identical to the request made by the client to the proxy server 120 with respect to any parameter that is not directed towards to proxy server 120. For example, the request may be identical with respect to protocol, browser identification, allowed encoding, language and content type, session and context objects, cookie files or the like. In additional the proxy server may provide Internet Protocol (IP) address of the client 110 to the server 130 as an additional informational parameter in order to identify the original customer. The request to the server 130 may omit, for example, the display width which is directed to the proxy server 120.

In step 315, the obtained web page may be preprocessed. The preprocessing may be performed with respect to directives that are client-dependant. For example, different directives may be used for different web browsers. The preprocessing may ignore (and remove) directives which are irrelevant for the client (e.g., directed to a client using a different operating system) and process relevant directives. The processed web page, therefore, does not include processing directives and simulates the processed web page that the client 110 would generate.

In step 320 the processed web page may be rendered to obtain a display representation. In some exemplary embodiments, the web page may be rendered using a rendering engine of a web browser. In some exemplary embodiments, the rendering engine that is used may be the rendering engine that is being used by the client 110 or a simulation thereof. In some exemplary embodiments, the rendering engine may be selected from a set of rendering engines available for the proxy server 120. In some exemplary embodiments, the rendering may comprise activating client-side scripts comprised by the web page. A “client-side script” is a program code comprised by a web page which is operated by the client displaying the web page. Client-side scripts may include JavaScript, Java applet, AJAX code, Flash objects, XML libraries, script based styles or the like.

In step 325, based on the display representation obtained in step 320, a width of the display representation may be measured. In some exemplary embodiments, the width may be measured in pixels used in the display representation.

In step 330, a proportion between the display width and the computed width may be determined. In some exemplary embodiments, the display width is decreased by pixels reserved for displaying a border. Alternatively, the width of the display representation may be to increased by pixels reserved for displaying the border. The proportion may be indicative to a modification of the size of graphical elements of the web page. For example, if the proportion is 0.75, than each graphical element may be reduced to 75% of its size. Alternatively, if the proportion is 1.2 than each graphical element may be increased to 120% of its size

In step 335, rendering directives in the web page may be modified to modify the size of the elements by the proportion. In some exemplary embodiments, a rendering directive may be associated with a width and height attribute. The attributes may be modified by the proportion. For example, provided a proportion of 50%, instead of having a width of 100 pixels and height of 200 pixels, the size is modified to width of 50 pixels and a height of 100 pixels, retaining the same aspect ratio. In some exemplary embodiments, the attributes may be provided in percentage of the actual size of the object. For example, an image may be displayed at 60% of its size. The attribute may be modified so that the percentage is modified by the proportion. Additionally or alternatively, there may not be any rendering attribute associated with an object, in which case the proxy server 120 may analyze the object to determine the size of the object and optionally add rendering attributes accordingly. An attribute may be inserted in order to instruct a browser rendering the page to modify its size by the proportion. It will be noted that rendering directives may be style definitions associated with the web page, an element of the web page, layout thereof, such as pertaining to size, position, fonts, borders and the like.

In some exemplary embodiments, the use of a rendering directive may enable for fast processing and transformation of the web page. Therefore, reducing overhead processing time and enabling for an on-the-fly processing without substantially hindering the user's experience. The client 110 renders each page it displays. Therefore, adding the rendering instruction bears very limited overhead, if any, on the rendering performed by the client.

In some exemplary embodiments, each element of the web page may be modified, such as using appropriate rendering directives, by the proportion. Thereby, the size of the web page may be modified by the proportion, the width of the modified web page may be the desired display width, and the layout of the web page may remain unmodified.

In step 340, links in the web page may be modified. The modified links may be directed to the proxy server 120. For example, a URL such as “www.domain.com/path/file” may be modified to a URL directed to the proxy server 120, such as “www.proxy-server.com/?link=www.domain.com/path/file”. The link to the proxy server 120 may be modified so as that upon following the link the proxy server may be provided with the display width. Additionally or alternatively, the computed proportion may be provided, thus enabling next processing by the proxy server 120 to skip step 330. Optionally, steps 320-325 may be skipped.

In some exemplary embodiments, some links may be modified to be processed by the proxy server 120. Some URLs in links may not be modified. Additionally or alternatively, unmodified URLs may be modified to cause the linked web page to be opened in a different web browser, different window of the same web browser, different tab of the same web browser, or otherwise in a different viewing manner than the web page. In some exemplary embodiments, URLs to other web sites, to sponsored links, or the like, may remain unmodified. In some exemplary embodiments, the determination may be performed based on a URL having a different domain than that of the web page. In some exemplary embodiments, the determination may be performed based on a link to web page that is in a predetermined repository of URLs.

In step 345, a client-side monitoring script may be embedded in the web page. The monitoring script may be configured to monitor modifications made to the display representation of the web page by client-side scripts. In some exemplary embodiments, the monitoring script may identify movements, creation of elements and elements changes performed by the execution of client-side scripts. For example, when using proportion of 0.5 and a client-side script (e.g., JavaScript code) is defined to change an image size to 100 px when the client moves the mouse on it, the monitor script may modify it to change the image size to 50 px instead. In some exemplary embodiments, the monitoring script may be used to dynamically modify elements presented by the client-side scripts, such as by introducing/modifying rendering directives. In some exemplary embodiments, the monitoring script may be used to prevent modifications to the display representation that would increase the width of the display representation. In some exemplary embodiments, the monitoring script may monitor creation of links and may modify the links so as to be directed to the proxy server 120. In some exemplary embodiments, the client-side script may direct the browser to a different URL and the monitoring script may be operative to cause the browsing to be performed via the proxy server 120. In some exemplary embodiments, the monitoring script may be configured to identify movement of elements and modify movement thereof based on the proportion. For example, if the element is moved to the left by 10 pixels in the original web page, the movement may be modified to 8 pixels only in a transformed web page of a proportion of 80%.

In step 350, an inline frame height modification script may be embedded in the web page. The inline frame height modification script may be operative to modify a height parameter of an inline frame within which the web page is being displayed. The inline frame height modification script may be operative to determine a display height of the display representation of the web page and optionally modify the inline frame height so as to be at least the display height. Thus, avoiding having a vertical scrollbar associated with the inline frame. It will be noted that a vertical scrollbar may be used in the page containing the inline frame as the height of the inline frame may exceed available display height.

In some exemplary embodiments, a use of an inline frame height modification script modifies the height of a component of a web page (in this paragraph, “containing web page”) that contains the web page being processed (in this paragraph, “processed web page”). Thus, a designer of the containing web page need not know the required height of the processed web page, as the height may be dynamically modified. A person of ordinary skill in the art may appreciate additional advantages of using the inline frame height modification script.

In step 355, inlining directives in the web page to external files, such as CSS files, XML files, HTML files, JavaScript files, image files, or the like, may be replaced by the content of the external files. In some exemplary embodiments, inlining the external files may so be performed as part of the preprocessing step 315.

In step 360, a default font size in the web page may be set, if missing. In some exemplary embodiments, adding the default font size may enable controlling font sizes, and optionally modify them according to the proportion.

In step 365, the processed web page, also referred to as a transformed web page, may be sent to the client. The transformed web page may be sent as a response to the client request of step 300. In some exemplary embodiments, an HTTP response packet may be sent from the proxy server 120 to the client 110. The HTTP response packet may indicate a content type according to the document type received by the proxy server 120 in step 310. Note that in some exemplary embodiments, the proxy server 120 may handle a plurality types of web page files. Additionally or alternatively, the proxy server 120 may be adapted to handle different types of files (e.g., HTML document, XML document, JS library, CSS document, image, flash, etc.), such as in response to a modified link being followed from the transformed web page.

In step 370, the transformed web page may be displayed by the client 110 in a display component. For example, the transformed page may be displayed within the second page 210, within an inline frame.

In step 375, one or more client-side scripts may be operated by the client 110. The client-side scripts may be an inline frame height modification script, a monitoring script, an event trapping script, a client-side script being monitored by the monitoring script, or the like.

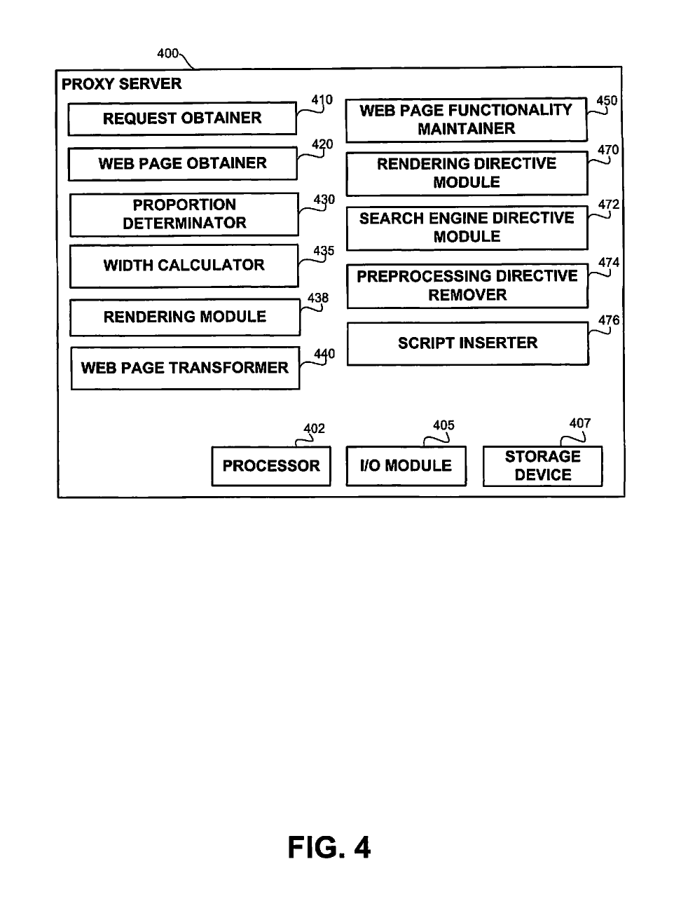

Referring now to FIG. 4 showing a proxy server in accordance with some exemplary embodiments of the disclosed subject matter. A proxy server 400, such as 120 of FIG. 1, may be configured to be responsive to requests from clients to obtain a web page and modify the web page based on a display region available to display the web page by the client. The proxy server 400 may be utilized to perform steps 305-365 of the method of FIG. 3. Unless otherwise indicated, each subcomponent of proxy server 400 is optional and may be omitted in some exemplary embodiments.

A request obtainer 410 may be configured to obtain requests from clients. The request obtainer 410 may be configured to analyze the request. In some exemplary embodiments, the request obtainer 410 may perform steps 300 and/or 305 of the method depicted in FIG. 3.

A web page obtainer 420 may be configured to obtain the web page based on the request. In some exemplary embodiments, the web page obtainer 420 may be responsive to the request obtainer 410 so as a web page is obtained in response to a request, in an on the fly manner. In some exemplary embodiments, a web page obtainer 420 may obtain the web page from a web server 130. In some exemplary embodiments, the web page obtainer 420 may perform step 310 of the method depicted in FIG. 3.

A proportion determinator 430 may be configured to determine a proportion between the predetermined width and the width. In some exemplary embodiments, the proportion may be computed based on the two width measurements. In some exemplary embodiments, the proportion may be determined based on the request obtained by the request obtainer 410. In some exemplary embodiments, the request may comprise the proportion. For example, the proportion may be provided as a POST or GET HTTP parameter. In some exemplary embodiments, a link that is modified by the proxy server 400 (e.g., using the web page functionality maintainer 420, as is disclosed hereinbelow) may be modified so as to provide the proportion in addition to or instead of the display width. In some exemplary embodiments, the proportion determinator 430 may perform step 330 of the method depicted in FIG. 3.

A width calculator 435 may be configured to calculate the width of the obtained web page. The calculated width may be used by the proportion determinator 430. The width may be calculated based on a display representation of the web page, such as obtained after rendering the web page. In some exemplary embodiments, the width calculator 435 may be configured to add/reduce pixels to the width in order to compensate for borders, padding, or the like. In some exemplary embodiments, the width calculator 435 may perform step 325 of the method depicted in FIG. 3.

A rendering module 438 may be configured to render the web page thereby generating a display representation of the web page. In some exemplary embodiments, the rendering module 438 may simulate rendering to be performed by the client 110 to display the web page. In some exemplary embodiments, the rendering module 438 may select a rendering engine out of a plurality of available rendering engines based on the client 110. For example, in case the client 110 uses a Google® Chrome® browser, the rendering module 438 may utilize the same rendering engine of Chrome® or a rendering engine that simulates rendering performed by this browser. In case that the client 110 uses a Microsoft® Internet Explorer® browser, a different rendering engine may be utilized. In some exemplary embodiments, the rendering module 438 may perform step 320 of the method depicted in FIG. 3.

A web page transformer 440 may be operative to generate a transformed web page based on the obtained web page. The transformed web page may be a modified version of the web page. The transformed web page may have a modified display representation having substantially the same layout as the display representation of the obtained web page, but having a different width, such as the display width. In some exemplary embodiments, some elements may be removed, such as blocked content (black-listed elements, elements not in a white-list, advertisements, banners, or the like), and therefore the layout may be non-substantially modified. In some exemplary embodiments, the modified display representation may be modified by the proportion determined by the proportion determinator 430. In some exemplary embodiments, the web page transformer 440 may perform steps 335 and/or 360 of the method depicted in FIG. 3.

A rendering directive module 470 may be configured to mark the web page with rendering directives. In some exemplary embodiments, the transformed web page may be modified by introducing rendering directives to cause elements to be modified by the proportion. The rendering directive module 470 may parse the web page to identify the elements to be modified (e.g., using regular expressions, using a formal grammar, or the like). Parsing may be performed to identify elements, existing rendering directives that may be modified, or the like. In some exemplary embodiments, the rendering directive module 470 may be utilized by the web page transformer 440. In some exemplary embodiments, the rendering directive module 470 may perform step 335 of the method depicted in FIG. 3.

A web page functionality maintainer 450 may be configured to modify the web page so as to cause links in the web page to be processed by the proxy server 400. Thereby, functionality of the web page may be maintained, and the linked pages may be processed to be modified by the proportion to be displayed in the same display as the web page. In some exemplary embodiments, the web page functionality maintainer 450 may be configured to preserve the functionality of objects embedded in the web page, such as Flash object, JavaScript scripts or the like. In some exemplary embodiments, the web page functionality maintainer 450 may modify client-side script so as to trap predetermined events. For example, in case the web page is displayed within an iFrame, events that may cause the browser to browse away from the iFrame, such as, in accordance with Document Object Model (DOM), modification of the “top.location” data member may modify the location of the window object at the top of the page being displayed, and therefore may cause the browser to leave the location containing the iFrame. Such modification may be identified by the web page functionality maintainer 450 and modified to relate to the location data member of the iFrame window object instead. Additionally or alternatively, modification of such data members may be monitored using a script which may dynamically catch modifications and prevent them. It will be noted that web page functionality maintainer 450 may relate to different data members of the DOM and/or to other types of functional operation by the web page which are now obvious to a person of ordinary skill in the art in view of the present disclosure. In some exemplary embodiments, the web page functionality maintainer 450 may perform step 340 of the method depicted in FIG. 3.

In some exemplary embodiments, a designer of a third-party web page may utilize the proxy server 400 by using a URL of the proxy server 400 and designing a request to the proxy server 400 to load a desired web page in a display width. The web page functionality maintainer 450 may modify the web page such that all linked web pages are also modified, without having the designer to modify the web page manually. It will be noted that, the disclosed subject matter may be useful also in case the designer cannot modify the web page itself, but would still like to enabling loading of a modified version thereof. The proxy server 400 is useful in dynamically modifying the web page even though the original web page remains unmodified. In some cases, a user of the proxy server 400 cannot modify the web page retained on a web server, such as due to lack of permissions to modify the files thereon. Still, the user is able through the use of the disclosed subject matter to enable users of the web site to view a modified version thereof. For example, the user may be a person responsible of the Facebook® page of a company, whereas the web page itself is designed by another designer. The user may utilized the disclosed subject matter to design the Facebook® page to contain a modified version of the web page, such as the web page in a reduced sized-version, although the user has no ability to change the web page itself.

A search engine directive module 472 may be configured to introduce or modify search engine directives in the web page. The search engine directives may indicate to a search engine not to index the transformed web page. Additionally or alternatively, the search engines directives may indicate not to follow links in the transformed web page. Other search engine directives may be used. In some exemplary embodiments, the search engine directives may avoid having substantially the same web page indexed twice—once in its original version and once in the modified version. Duplicate indexing may be undesired as some search engines may remove both duplicates from the search engine considering the content duplicative against in the search engine policy. Additionally or alternatively, when the web page is accessed not through inlining in a component or otherwisely being displayed within a component and/or having a limited display width, the original version of the web page should be displayed and not the transformed version. Therefore, the preventing the transformed web page to be indexed may be beneficial.

A preprocessing directive remover 474 may be configured to perform preprocessing of the web page based on preprocessing directives. The preprocessing directives may be inlining directives (e.g. include content of an external file). The preprocessing directives may be browser-dependant. In some exemplary embodiments, the preprocessing directives may be either relevant or irrelevant to a specific client, such as the client 110, based on the configuration thereof. Directives that are irrelevant to the client 110 (i.e., client from which the request was received) may be removed by the preprocessing directive remover 474. Directives that are relevant to the client 110 may be processed and replaced by their outcome. In some exemplary embodiments, the preprocessing directive remover 474 may be configured to perform substantially the same preprocessing operations as the client 110. Thereby, preventing a need to perform duplicative processing (e.g., once by the proxy server 400 and once by the client 110) of the preprocessing directives. In some exemplary embodiments, the preprocessing directive remover 474 may perform steps 315 and/or 355 of the method depicted in FIG. 3.

A script inserter 476 may be configured to introduce client-side script to the web page. The client-side scripts may be monitoring script, may be inline frame height modification script, or the like. The inserted script may be a template script or based thereof. The template script may be provided a-priori to the script inserter 476. The script inserter 476 may be configured to perform steps 345 and/or 350 of the method depicted in FIG. 3.

In some exemplary embodiments, the proxy server 400 may comprise a processor 402. The processor 402 may be a Central Processing Unit (CPU), a microprocessor, an electronic circuit, an Integrated Circuit (IC) or the like. The processor 402 may be utilized to perform computations required by the proxy server 400 or any of it subcomponents.

In some exemplary embodiments of the disclosed subject matter, the proxy server 400 may comprise an Input/Output (I/O) module 405. The I/O module 405 may be utilized to retrieve a web page, external file or the like, to send a transformed web page, external file, or the like.

In some exemplary embodiments, the proxy server 400 may comprise a storage device 407. The storage device 407 may be a hard disk drive, a Flash disk, a Random Access Memory (ROM), a memory chip, or the like. In some exemplary embodiments, the storage device 407 may retain program code operative to cause the processor 402 to perform acts associated with any of the subcomponents of the proxy server 400. In some exemplary embodiments, the storage device 407 may retain the obtained web page, the determined proportion, the rendering output, the transformed web page, the template script or the like.

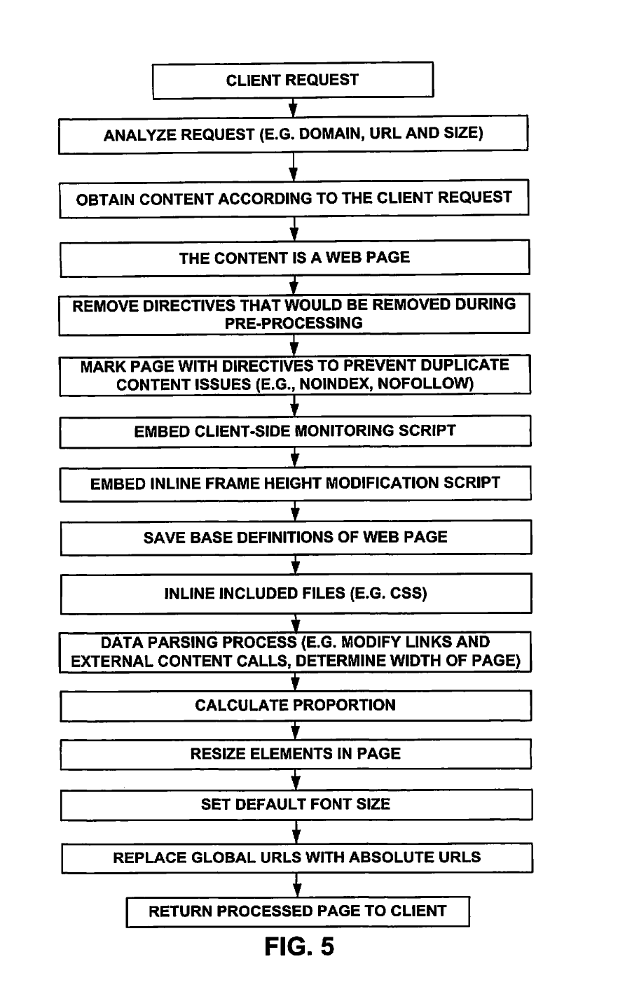

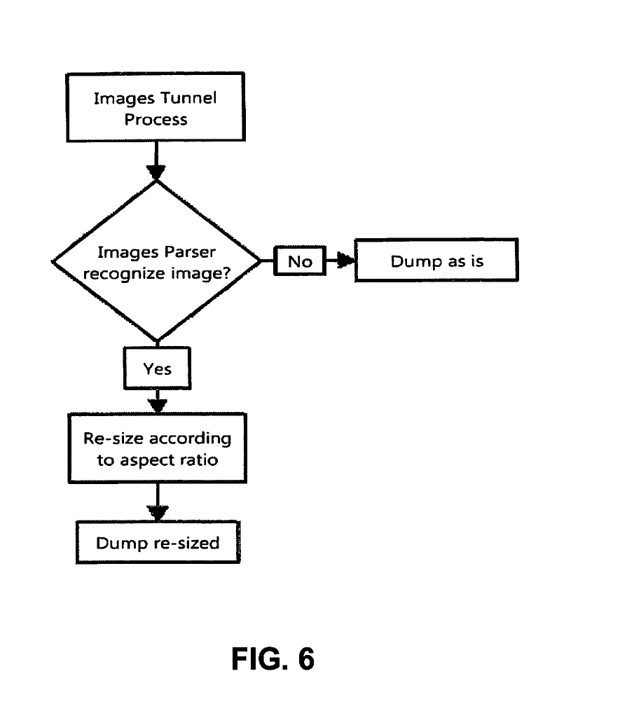

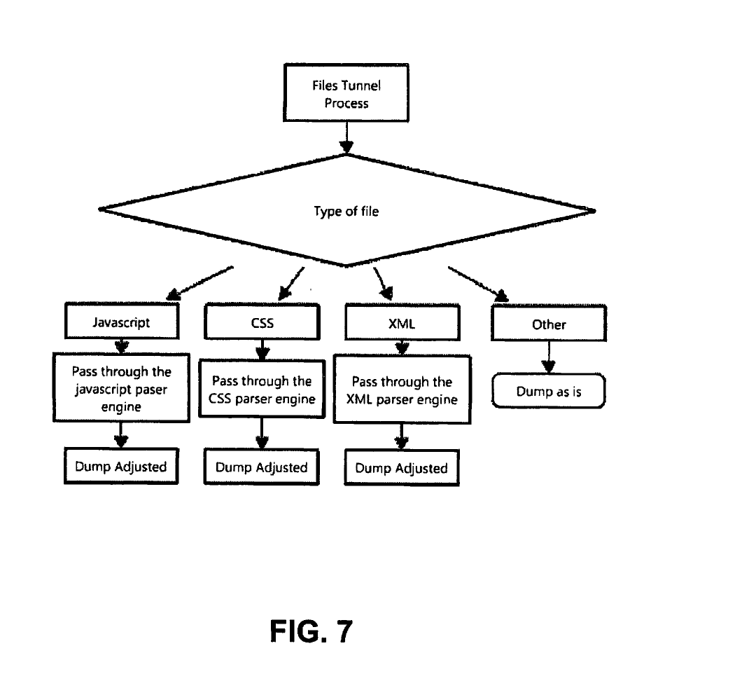

Referring now to FIGS. 5-7 showing exemplary methods in accordance with some exemplary embodiments of the disclosed subject matter. The method of FIG. 5 deals with a content being obtained by the proxy server 120 that is identified as a web page. The method of FIG. 6 shows processing of an image by the proxy server 120. The method of FIG. 7 shows processing of different types of files by the proxy server 120.

FIG. 5 shows that a request is obtained from client, analyzed, and content obtained based thereof. In case the content is a web page, the process continues, otherwise, a different process (“tunnel”) may be performed, based on the type of the obtained content. The method further comprises removing preprocessing directives, marking the page with directives for search engines, embedding client-side monitoring script and inline frame height modification script. In some exemplary embodiments, “BASE” definition of the page may be searched and saved for future references while searching for files, images and other resources absolute paths. Included files may be inlined to the web page. Additionally or alternatively, the web page may be parsed and processed such as by modifying links and external content calls to be directed to the proxy server 120. Additionally or alternatively, width of the display representation of the page may be determined. Additionally or alternatively, the proportion may be calculated. Additionally or alternatively, elements having graphical representation may be modified and resized based on the proportion. Additionally or alternatively, default font size may be set in the web page. Additionally or alternatively, global URLs may be replaced by absolute URLs, when applicable. It will be noted that absolute URLs may speed performance as there is no need to determine to which server a request should be issued to receive the content. Moreover, absolute URLs may reduce likelihood of referring to the same content using different addresses, which may result in providing better and more efficient outcome such as enabling a better use of a caching mechanism.

FIG. 6 shows exemplary processing of an image by the proxy server 120. It will be noted that in some instances rendering directives operative to resize the image may not be used. For example, an image used as a background of an HTML page cannot traditionally be resized using a rendering directive. In some cases, resizing may be possible but not desired and thus avoided. FIG. 6 shows processing of a request to obtain an image by the proxy server 120. The request is to obtain an image that is to be resized by the proxy server 120 and which was not resized by a rendering directive.

Consider an HTML element <img src=“domain/path”>, the disclosed subject matter may modify the HTML element by introducing a rendering directive <img width=“100”height=“50” src=“domain/path”>. Alternatively, the disclosed subject matter may direct a request to the proxy server 120, which will, in turn, resize the image and provide the resized image to the client. The HTML element may be, for example, <img src=“proxy server/?domain/path”>. In response to rendering the HTML element, a browser may send a request directed to the proxy server with the argument “domain/path”. Optionally, another argument is provided signifying that that file is being used as an image file. The proxy server 120 may, in response to receiving the request, obtain the image from its location (i.e., “domain/path”) and process the image in the image tunneling process, such as disclosed in FIG. 6.

If the image type is recognized (e.g., based on file format, header content, Meta data of the file, or the like), the image may be resized using a resizing algorithm pertinent to the type of the image. The resizing may be based on the proportion, while preserving the aspect ratio of the image. The resized image may be returned by the proxy server 120 to the client 110. In some exemplary embodiments, the type of image is not recognized and resizing may not be practical by the proxy server 120. The proxy server 120 may provide the image in its original version in order to avoid losing data in this exceptional case. In some exemplary embodiments, such images may be stored for debugging purposes and optionally an alert may be issued to a programmer to inspect the unrecognized file.

In some exemplary embodiments, resized images may be stored and a caching mechanism may be utilized to avoid resizing the same images again.

FIG. 7 shows exemplary processing of files by the proxy server 120. Based on the type of file, different processing may be performed. JavaScript files may be parsed and modified so as to maintain functionality while causing links to URLs to be processed via the proxy server 120. Additionally or alternatively, CSS and XML files may also be processed in a similar manner. In some exemplary embodiments, files of other types (in this example, of any type other than JavaScript, CSS or XML) may be provided as-is without further processing by the proxy server 120.

In some exemplary embodiments, scripts inserted by the proxy server of the disclosed subject matter may be adapted for specific types of browsers. For example, different scripts may provide the same functionality with respect to different browsers. The scripts that the proxy server inserts may be dynamically adapted to the browser of the user, such as based on a dynamic identification of the browser used by the user. Additionally or alternatively, the scripts may be statically adapted to different browsers, and each browser would execute different portions thereof, specifically adapted to the browser.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method, the method performed by a computerized device, the method comprising:
receiving a request to obtain a web page to be displayed within a display component having a predetermined width;
obtaining the web page, the web page having a first display representation, the first display representation having a layout of graphical elements, the first display representation having a different width than the predetermined width;
determining a proportion between the predetermined width and the different width;
generating a transformed web page based on the proportion, the transformed web page having a second display representation, the second display representation having the predetermined width, the second display representation retaining the layout of elements, wherein sizes of elements of the layout are proportionally modified based on the proportion.

2. The computer-implemented method of claim 1, further comprising providing the transformed web page in response to the request.

3. The computer-implemented method of claim 1, wherein the display component is an inline frame of another web page.

4. The computer-implemented method of claim 1, further comprises:
rendering the web page, whereby the first display representation is obtained; and
determining the width based on the rendered web page.

5. The computer-implemented method of claim 4, wherein said rendering comprises operating a client-side script comprised by the web page.

6. The computer-implemented method of claim 1, wherein said obtaining, said determining and said generating are performed on-the-fly in response to said receiving.

7. The computer-implemented method of claim 1, wherein said generating the transformed web page comprises:
marking the transformed web page with a rendering directive operative to cause rendering of an element of the graphical element to be performed so as to modify the size of the element according to the proportion.

8. The computer-implemented method of claim 1, wherein said generating the transformed web page comprises:
identifying a link in the web page to a linked web page; and
modifying the link in the transformed web page, wherein the modified link is directed to the computerized device and operative to issue a second request to obtain the linked web page to be displayed within the display component.

9. The computer-implemented method of claim 1, wherein said generating the transformed web page comprises marking transformed web page with a search engine directive operative to prevent indexing of the transformed web page by a search engine.

10. The computer-implemented method of claim 1, wherein
the request indicative of a tool that is to be used to display the web page;
wherein the web page comprises one or more processing directives, the processing directives comprises relevant and irrelevant directives with respect to the tool; and
wherein said generating comprises:
removing the irrelevant processing directives so that they are not included in the transformed web page; and
processing the relevant directives and including processing outcome in the transformed web page.

11. The computer-implemented method of claim 1,
wherein the web page comprises a directive operable to cause a tool displaying the web page to obtain a file in order to render the web page; and
wherein said generating further comprises:
modifying the directive to either cause retrieval of the file indirectly by the computerized device or to be replaced with content of the file.

12. The computer-implemented method of claim 11, wherein the file is selected from a group consisting of an extensible markup language (XML) file, a cascading style sheet (CSS) file, an image file and a script file.

13. The computer-implemented method of claim 1, wherein said generating further comprises:
introducing a monitoring script to the transformed web page operable to monitor operations of a client-side script; and
wherein the monitoring script is operable to modify elements of the transformed web page in response to a modification by the client-side script, wherein the modification by the monitoring script is in accordance with the proportion.

14. The computer-implemented method of claim 1, wherein said generating further is comprises:
introducing a script to the transformed web page operable to determine height of the second display representation in response to rendering of the transformed web page; and
wherein the script is further operable to modify a height of the display component to be at least of the determined height.

15. A proxy server, the proxy having a processor and memory device, the proxy comprising:
a request obtainer operable to obtain a request to retrieve a web page to be displayed within a display component having a predetermined width;
a web page obtainer operable to obtain the web page from a web server, the web page having a first display representation, the first display representation having a layout of graphical elements, the first display representation having a width;
a proportion determinator operative to determine a proportion between the predetermined width and the width;
a web page transformer operative to generate a transformed web page based on the web page and the proportion, the transformed web page having a second display representation, the second display representation having the predetermined width, the second display representation retaining the layout of elements, whereby sizes of elements of the layout are proportionally modified based on the proportion.

16. The proxy server of claim 15, further comprising:
a provider module operative to provide the transformed web page to a client; and
wherein the request is issued by the client.

17. The proxy server of claim 15, wherein said web page transformer is operatively coupled to a web page functionality maintainer, wherein said web page functionality maintainer is operative to adapt the transformed web page so as to cause functionality of the web page that is associated with a server request to be provided to said proxy server.

18. The proxy server of claim 15, wherein said web page transformer is operatively coupled to a rendering module, wherein said rendering module operative to render the web page; and wherein said proxy server further comprising a width calculator operative to calculate the width based on the rendered web page.

19. The proxy server of claim 15, further comprises:
a rendering directive module configured to mark the transformed web page with a rendering directive operative to cause rendering of an element of the graphical element to be performed so as to modify the size of the element according to the proportion;
a search engine directive module configured to mark transformed web page with a search engine directive operative to prevent indexing of the transformed web page by a search engine;
a preprocessing directive remover configured to perform preprocessing of processing directives comprise by the web page, whereby irrelevant processing directives are removed and the transformed web page comprises processing outcome of the relevant directives; wherein relevance of directives is determined with respect to characteristics of a client, wherein the client has performed the request obtained by said request obtainer; and
a script inserter configured to introduce a monitoring script to the transformed web page operable to monitor operations of a client-side script, and wherein the monitoring script is operable to prevent dynamic modification of the predetermined width of the second display representation.

20. A computer program product, the product comprising:
a non-transient computer readable medium;
a first program instruction for receiving a request to obtain a web page to be displayed within a display component having a predetermined width;
a second program instruction for obtaining the web page, the web page having a first display representation, the first display representation having a layout of graphical elements, the first display representation having a different width than the predetermined width;
a third program instruction for determining a proportion between the predetermined width and the different width;
a fourth program instruction for generating a transformed web page based on the proportion, the transformed web page having a second display representation, the second display representation having the predetermined width, the second display representation retaining the layout of elements, wherein sizes of elements of the layout are proportionally modified based on the proportion; and
wherein said first, second, third, and fourth program instructions are stored on said non-transient computer readable medium.
